(19) United States
(12) Patent Application Publication
(10) Pub. No.: US 2026/0236073 A1
(43) Pub. Date: Aug. 13, 2026

(54) ELECTRONIC APPARATUS

(71) Applicant: Lenovo Japan LLC, Tokyo (JP)

(72) Inventors: Mizuki Itoyama, Kanagawa (JP); Dante Eco Gomez, Kanagawa (JP); Fusanobu Nakamura, Kanagawa (JP); Tabito Miyamoto, Kanagawa (JP)

(73) Assignee: Lenovo Japan LLC, Tokyo (JP)

(21) Appl. No.: 19/450,346

(22) Filed: Jan. 15, 2026

(30) Foreign Application Priority Data
Feb. 13, 2025 (JP) 2025-021671

(51) Int. Cl. G06F 1/20; G06F 1/16

(52) U.S. Cl. CPC G06F 1/203; G06F 1/1656

(57) ABSTRACT

An electronic apparatus includes: a chassis; a substrate mounted with a heating element and supported by the chassis; a heat diffusion member having a metal plate and capable of diffusing heat of the heating element; and a fan having a fan chassis including an opening surface on one side of the fan chassis, and a fan blade supported within the fan chassis. The heat diffusion member is fixed to at least one of the chassis and the substrate with a first screw. The fan chassis is fixed to the metal plate with a second screw, and the opening surface is closed by the metal plate.

### CROSS-REFERENCE TO RELATED APPLICATIONS

This application claims priority to Japanese Patent Application No. 2025-021671 filed on Feb. 13, 2025, the contents of which are hereby incorporated by reference in its entirety.

### BACKGROUND

### Technical Field

The present invention relates to an electronic apparatus provided with a fan.

### Description of Related Art

An electronic apparatus such as a laptop PC is mounted with a heating element such as a CPU. Such an electronic apparatus is mounted with a thermal module within a chassis and is capable of absorbing heat from a heating element and radiating the heat to the outside. In Japanese Patent No. 7254891, the applicant of the present invention has proposed a configuration in which a cover plate of a fan chassis also serves as a vapor chamber, thereby enhancing cooling performance. Further, in Japanese Patent No. 7371170, the applicant of the present invention has proposed a configuration in which a heat pipe fixed to a vapor chamber is connected to a heat sink fixed to a fan.

In the thermal module described above, it is rare for the vapor chamber, the heat pipe, and the like to fail. On the other hand, the fan can fail and needs to be replaced. However, in the configuration of Japanese Patent No. 7254891, the fan is fixed integrally to the vapor chamber. In the configuration of Japanese Patent No. 7371170, the fan is fixed integrally to the vapor chamber via the heat sink and the heat pipe. Therefore, in these conventional configurations, the entire thermal module had to be replaced in order to replace the fan.

If it is possible to easily replace a failed fan independently, not only does it reduce repair costs, but it is also desirable from an ESG (Environment, Social, Governance) perspective. Incidentally, in the configuration of Japanese Patent No. 7371170, when the heat pipe and the fan are fixed separately, it is possible to replace the fan alone, but this reduces the cooling performance of the entire module.

### SUMMARY

The present invention has been made in consideration of the problems in the prior art described above. An object of the present invention is to provide an electronic apparatus capable of ensuring cooling performance and further allowing a fan to be replaced independently.

An electronic apparatus according to one aspect of the present invention includes a chassis, a substrate mounted with a heating element and supported by the chassis, a heat diffusion member having a metal plate and capable of diffusing heat of the heating element, and a fan having a fan chassis including an opening surface on one side of the fan chassis, and a fan blade supported within the fan chassis. The heat diffusion member is fixed to at least one of the chassis and the substrate with a first screw. The fan chassis is fixed to the metal plate with a second screw, and the opening surface is closed by the metal plate.

The above-described one aspect of present invention can ensure cooling performance and further replace the fan independently.

### BRIEF DESCRIPTION OF THE DRAWINGS

FIG. 1 is a top-down schematic plan view of an electronic apparatus according to one embodiment;

FIG. 2 is a plan view schematically illustrating an internal structure of a chassis;

FIG. 3 is a schematic perspective view of a thermal module;

FIG. 4 is a schematic perspective view of a fan;

FIG. 5 is a schematic cross-sectional side view of the thermal module and the chassis at its peripheral portion; and

FIG. 6 is a cross-sectional side view illustrating a replacement operation of the fan illustrated in FIG. 5.

### DETAILED DESCRIPTION

Hereinafter, preferred embodiments of an electronic apparatus according to the present invention will be given and described in detail with reference to the accompanying drawings.

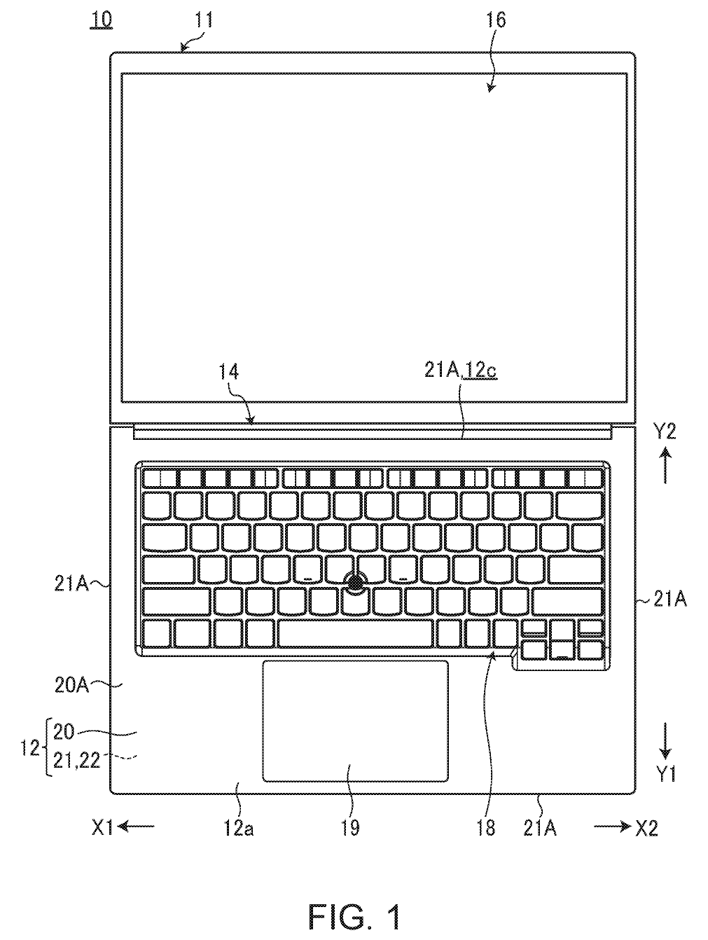

FIG. 1 is a top-down schematic plan view of an electronic apparatus 10 according to one embodiment. As illustrated in FIG. 1, the electronic apparatus 10 of the present embodiment is a clamshell laptop PC. The electronic apparatus 10 has a configuration in which a lid 11 and a chassis 12 are connected by a hinge 14 so as to be capable of rotating relative to each other. In the present embodiment, although the electronic apparatus 10 of the laptop PC is illustrated, the electronic apparatus may be, for example, a desktop PC, a tablet PC, a smartphone, a portable game machine, or the like other than the laptop PC.

The lid 11 is a thin, flat and box-shaped chassis. The lid 11 is mounted with a display 16. The display 16 is, for example, an organic EL display or a liquid crystal display.

The chassis 12 is a thin and flat box body. A keyboard device 18 and a touchpad 19 face an upper surface (surface 12a) of the chassis 12. Hereinafter, the chassis 12 and each of components mounted thereon will be described based on the posture of an operator operating the keyboard device 18 with the width direction (left and right) of the chassis 12 referred to as X1 and X2 directions, the depth direction (front and rear) of the chassis 12 referred to as Y1 and Y2 directions, and the thickness direction (top and bottom) of the chassis 12 referred to as Z1 and Z2 directions, respectively. The X1 and X2 directions may be collectively referred to as an X direction, and the Y1 and Y2 directions and the Z1 and Z2 directions may be similarly referred to as a Y direction and a Z direction respectively. These directions are determined for the convenience of description, and may of course change depending on the use state, installation attitude of the electronic apparatus 10, or the like.

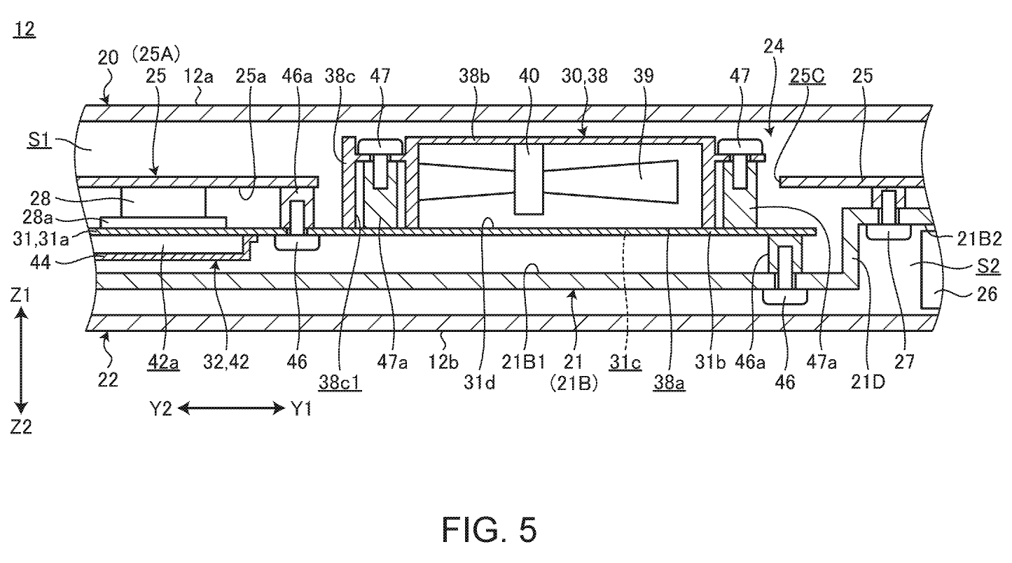

The chassis 12 may have a structure in which a first cover member 20, a frame member 21, and a second cover member 22 are stacked in order from top to bottom (see also FIG. 5). In the chassis 12, the cover members 20 and 22 are each detachably connected to the intermediate frame member 21 using screws, hook structures, or the like.

The first cover member 20 is a plate-like member which forms a surface 12a of the chassis 12. The keyboard device 18 is fixed to the first cover member 20. The touchpad 19 may be fixed to the first cover member 20 or to the frame member 21. The second cover member 22 is a plate-like member which forms a lower surface (bottom surface 12b) of the chassis 12. The cover members 20 and 22 can be formed of, for example, a metal material, a resin material, or a fiber-reinforced resin material. The cover members 20 and 22 may be formed, for example, from a pressed product of aluminum or the like.

The frame member 21 is an intermediate frame which forms the skeleton of the chassis 12. The frame member 21 serves as a mounting frame for the components mounted within the chassis 12. The components include electrical parts such as a thermal module 24, a substrate 25, and a battery device 26 to be described later as well as mechanical parts such as the hinge 14.

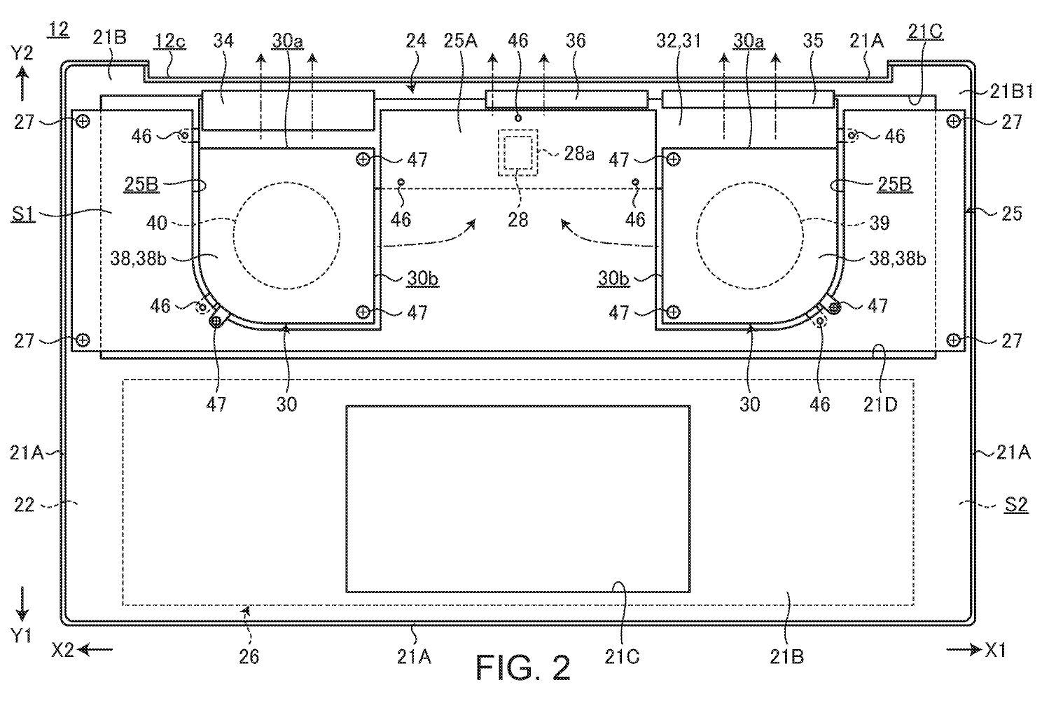

The frame member 21 has, for example, standing walls 21A which form four circumferential side surfaces of the chassis 12 and a component support portion 21B to which the above components are attached (see also FIG. 2). A part of the four circumferential standing walls 21A may be provided on the cover members 20 and 22. The component support portions 21B extend almost in a lattice or mesh form inside the standing walls 21A. Thus, opening portions 21C are formed at respective locations of the component support portion 21B in the Z direction. The component support portion 21B may have a step 21D in the Z direction, for example, at approximately the center in the Y direction. Thus, the interior of the chassis 12 is partitioned into a first space S1 in which the height between the first cover member 20 and the frame member 21 is increased, and a second space S2 in which the height between the second cover member 22 and the frame member 21 is increased (see FIG. 5).

The chassis 12 is not limited to the three-layer structure described above. For example, the frame member 21 may be omitted. In this case, it is preferable that the inner surface of one of the cover members 20 and 22 supports the above-described components.

The hinge 14 is installed in a concave hinge arrangement groove 12c formed in a rear edge of the chassis 12, and connects the chassis 12 and the lid 11 to each other. The hinge 14 has a structure in which, for example, hinge shafts serving as rotational axes are supported at both ends in the longitudinal direction of a hinge chassis.

FIG. 2 is a plan view schematically illustrating an internal structure of the chassis 12. FIG. 2 is a view illustrating the internal structure of the chassis 12 as seen from above with the first cover member 20 removed. As illustrated in FIG. 2, the thermal module 24, the substrate 25, and the battery device 26 are accommodated inside the chassis 12. Various electronic components, mechanical components, etc. are further provided inside the chassis 12.

The substrate 25 is a circuit board which serves as a motherboard of the electronic apparatus 10. The substrate 25 is arranged closer to the Y2 side of the chassis 12 and extends in the X direction. The substrate 25 is attached to a support surface 21B1 of the component support portion 21B facing the Z1 side and is accommodated in the first space S1. The substrate 25 is placed on the support surface 21B1 and is fixed to the frame member 21 at respective points with screws 27. FIG. 2 illustrates a configuration in which the four corners of the substrate 25 are fastened to the frame member 21 from the Z1 side with the screws 27. The screws 27 may fasten the substrate 25 to the frame member 21 from the Z2 side (see FIG. 5). The screws 27 may also be provided near the center of the substrate 25 (portion 25A).

The substrate 25 is mounted with a CPU (Central Processing Unit) 28. In addition to the CPU 28, the substrate 25 can mount various electronic components such as a GPU (Graphics Processing Unit), a memory, a communication module, etc. In the substrate 25, for example, the surface thereof (Z2 side surface) facing the support surface 21B1 side serves as a mounting surface 25a for the CPU 28 and the like (see FIG. 5).

The battery device 26 is a rechargeable battery which serves as a power source for the electronic apparatus 10. The battery device 26 is arranged closer to the Y1 side of the substrate 25 and extends in the X direction. The battery device 26 is attached to a support surface 21B2 of the component support portion 21B facing the Z2 side by screws, hook structures or the like, and is accommodated in the second space S2 (see also FIG. 5).

A configuration example of the thermal module 24 will next be described.

Of the electronic components mounted in the cassis 12, the CPU 28 is a heating element which has the largest amount of heat generation. The thermal module 24 can absorb and diffuses the heat generated by the CPU 28 and discharge it to the outside of the chassis 12. The substrate 25 also mounts heating elements around the CPU 28, such as a GPU, memory components, and power supply components. The thermal module 24 can also cool heating elements other than the CPU 28.

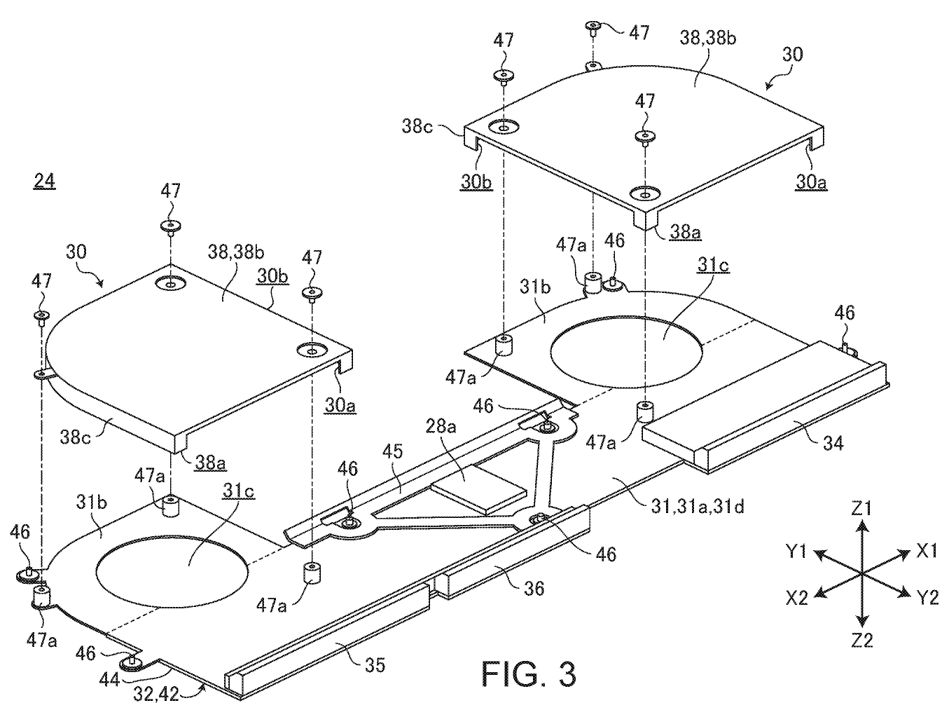

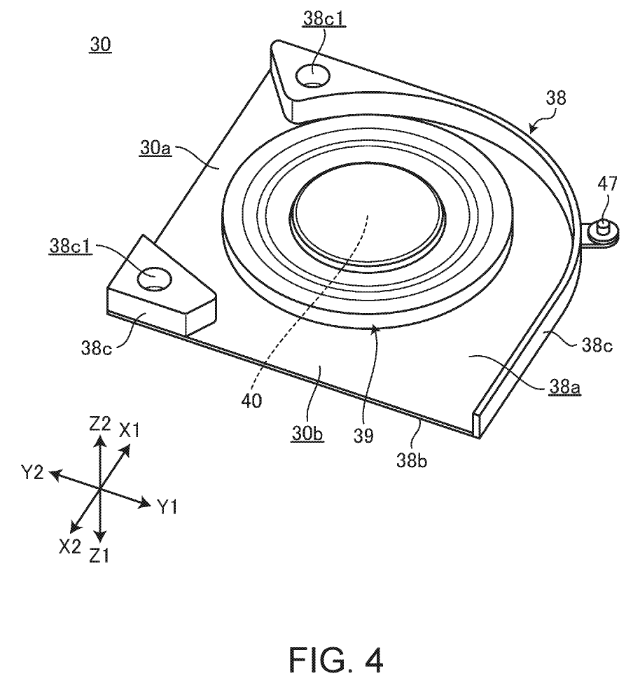

FIG. 3 is a schematic perspective view of the thermal module 24. FIG. 4 is a schematic perspective view of a fan 30. FIG. 5 is a schematic cross-sectional side view of the thermal module 24 and the chassis 12 at its peripheral portion. As illustrated in FIGS. 2 to 5, the thermal module 24 can include a pair of fans 30 and 30, a heat diffusion member 32 including a metal plate 31, and heat sinks 34 to 36.

The fans 30 and 30 are arranged side by side in the X direction, and straddle a part (portion 25A) of the substrate 25 between them. The left and right fans 30 and 30 can be configured to be identical or similarly except that they have bilaterally symmetrical structures each other. Therefore, in the present embodiment, the fans 30 will be collectively explained with the same reference numerals without any particular distinction being made therebetween. Of course, the left and right fans 30 and 30 do not have to be bilaterally symmetrical in structure. Only one fan 30 may be mounted.

In a plan view illustrated in FIG. 2, the substrate 25 has notch portions 25B on the left and right sides of the portion 25A. The left and right notch portions 25B have shapes which follow the outer shapes of the left and right fans 30. As a result, the fans 30 are inserted and disposed into the notch portions 25B (see also FIG. 5) and are arranged adjacent to each other in the X and Y directions with respect to the substrate 25.

As illustrated in FIGS. 3 to 5, the fan 30 includes a fan chassis 38, a fan blade 39, and a motor 40. The fan 30 has a configuration in which the fan blade 39 and the motor 40 are assembled in the fan chassis 38. The fan 30 can be configured with a centrifugal fan in which the fan blade 39 accommodated in the fan chassis 38 is rotated by the motor 40.

The fan chassis 38 is a box body in which one surface on the Z2 side is open at an opening surface 38a. The fan chassis 38 has a base plate 38b which forms the other surface on the Z1 side, and a side wall material 38c which forms an outer peripheral side surface.

The base plate 38b forms a surface opposite to the opening surface 38a of the fan chassis 38 in the axial direction of the fan blade 39 along the Z direction. The base plate 38b is a metal plate formed of, for example, stainless steel or the like. Since the fan 30 of the present embodiment does not have a suction port at the surface on the Z1 side, no opening serving as a suction port is formed in the base plate 38b. The base plate 38b may also have an opening similar to a suction port 31c to be described later.

The side wall material 38c stands upright in the Z2 direction from the outer peripheral edge of the base plate 38b. The side wall material 38c can be formed of, for example, a resin material or a metal material. The side wall material 38c has discharge ports 30a and 30b which are open at a side surface facing the Y2 direction and a side surface facing the X1 or X2 direction, respectively. In FIG. 2, the discharge port 30b is formed on the side surface on the X1 side of the left fan 30, and is formed on the side surface on the X2 side of the right fan 30. Thus, the discharge ports 30b and 30b of the right and left fans 30 face each other across the portion 25A. The fan 30 may have only one of the discharge ports 30a and 30b.

The fan blade 39 is an impeller having a plurality of blades arranged in the circumferential direction. The fan blade 39 is rotated by a driving force of the motor 40, and takes in air from the suction port 31c into the fan chassis 38, compresses it, and discharges it from the discharge ports 30a and 30b.

As illustrated in FIGS. 2 to 5, the heat diffusion member 32 is a member which absorbs and diffuses heat from the CPU 28 and the heating elements around it. A part of the heat diffused by the heat diffusion member 32 is transferred to the heat sinks 34 to 36. The heat diffusion member 32 is provided so as to cover the portion 25A of the substrate 25 together with the CPU 28 from the Z1 side.

The metal plate 31 is a thin metal plate-like member formed of a material with high thermal conductivity, such as copper or aluminum. The metal plate 31 in the present embodiment is a copper plate. As illustrated in FIG. 3, the metal plate 31 in the present embodiment has a substantially eyeglass shape. The metal plate 31 has a base plate part 31a and a pair of extension plate parts 31b. The base plate part 31a has a substantially band shape extending in the X direction. The extension plate parts 31b each protrude in the Y1 direction from both longitudinal end portions of the base plate part 31a. The outer shape of the extension plate part 31b corresponds to the outer shape of the fan 30. Each extension plate part 31b is formed with a circular hole 31c. In the configuration example illustrated in FIG. 2, a part of the hole 31c extends into the base plate part 31a.

The metal plate 31 also serves as a cover plate which closes the opening surface 38a of the fan 30 (see FIGS. 3 and 5). The hole 31c serves as the suction port 31c for the fan 30. That is, the metal plate 31 closes the opening surface 38a of the fan 30 to thereby form a space in the fan chassis 38 where the air is compressed by the fan blade 39. The suction port 31c may be formed in the base plate 38b of the fan chassis 38 instead of the metal plate 31.

The heat diffusion member 32 further includes a vapor chamber 42. The vapor chamber 42 is a plate-type heat transport device. The vapor chamber 42 has a sealed space 42a formed between two metal plates and filled with a working fluid. The vapor chamber 42 of the present embodiment forms a sealed space 42a between the metal plate 31 and a plate 44.

The plate 44 is a thin metal plate-like member formed of copper, aluminum, or the like as with the metal plate 31. The plate 44 in the present embodiment is a copper plate. The plate 44 has substantially the same outer shape as the base plate part 31a of the metal plate 31. That is, the sealed space 42a is formed between the plate 44 and the base plate part 31a (see FIG. 5). The sealed space 42a serves as a flow path through which the sealed working fluid flows while undergoing a phase change. Examples of the working fluid include, for example, water, a chlorofluorocarbon substitute, acetone or butane, etc. Incidentally, a wick transporting the condensed working fluid by capillary action is disposed within the sealed space 42a. The wick is formed of a porous material such as a mesh made of thin metal wires woven into a cotton-like shape or a fine flow path.

The vapor chamber 42 may use the two plates 44 and 44 to form the sealed space 42a without using the metal plate 31. In this case, the vapor chamber 42 may be configured such that the plate 44 on the Z1 side is joined to the base plate part 31a of the metal plate 31. Thus, when the metal plate 31 and the vapor chamber 42 are separately constructed, a heat pipe may be used instead of the vapor chamber 42. The heat pipe is one in which an internal space of a copper pipe crushed into a flat shape is formed as a sealed space in which a working fluid is sealed.

The heat sinks 34 to 36 have a structure in which a plurality of fins formed from thin metal plates are arranged at equal intervals in the X direction. Each fin stands in the Z direction and extends in the Y direction. A gap through which the air sent from the fan 30 passes is formed between the adjacent fins. The heat sinks 34 to 36 are formed of a metal with high thermal conductivity, such as aluminum or copper. The heat sinks 34 to 36 are fixed to a surface 31d of the metal plate 31 on the Z1 side.

As illustrated in FIGS. 2 and 3, the left and right heat sinks 34 and 35 face the discharge ports 30a of the fans 30 on the Y2 side, respectively. Thus, the air discharged from the discharge ports 30a passes through the heat sinks 34 and 35. The central heat sink 36 faces the portion 25A of the substrate 25. Thus, the air discharged from the discharge ports 30b of the fans 30 passes through the heat sink 36. Dashed-line arrows illustrated in FIG. 2 schematically illustrate the flow of the air discharged from the discharge ports 30a and 30b. The heat sinks 34 to 36 may be omitted.

Designated at reference numeral 28a in FIGS. 2 and 3 is a heat receiving plate connected to the surface 31d of the metal plate 31. The heat receiving plate 28a is, for example, a copper plate having an outer shape which is the same as or slightly larger than the outer shape of the CPU 28. The heat receiving plate 28a is thermally connected to the top surface of the CPU 28. The heat receiving plate 28a absorbs the difference in height between the CPU 28 and the metal plate 31 in the Z direction and enhances the adhesion between them. That is, the heat receiving plate 28a improves the efficiency of heat transfer from the CPU 28 to the heat diffusion member 32. A thermally conductive grease or the like may be applied between the heat receiving plate 28a and the CPU 28. The heat receiving plate 28a may be omitted.

Designated at reference numeral 45 in FIG. 3 is a reinforcing member. The reinforcing member 45 is, for example, a triangle-shaped frame member which surrounds the heat receiving plate 28a and is fixed to the surface 31d of the metal plate 31. The reinforcing member 45 increases the rigidity of the heat diffusion member 32 (metal plate 31) pressed against the CPU 28 via the heat receiving plate 28a, and improves the adhesion between the CPU 28 and the metal plate 31. The reinforcing member 45 may be omitted or may be replaced with a part having elasticity or the like.

As illustrated in FIGS. 2, 3, and 5, the heat diffusion member 32 is fixed to the substrate 25 and the frame member 21 with screws (first screws) 46. That is, the thermal module 24 is fastened to the substrate 25 and the frame member 21 with the screws 46. The screws 46 may be fastened, for example, from the Z2 side to the Z1 side. The screws 46 fasten, for example, tongue-shaped plate pieces projecting from respective points on the outer peripheral edge portion of the metal plate 31 to the substrate 25 and the frame member 21. Further, the screws 46 may be provided in the center of the vapor chamber 42 at positions where they penetrate the three corners of the reinforcing member 45. The heat diffusion member 32 may be fixed only to the substrate 25 or only to the frame member 21. For example, in the case of a configuration in which the chassis 12 does not have the frame member 21, the heat diffusion member 32 may be fixed to the cover members 20 and 22 with the screws 46. Even in the case of a configuration in which the chassis 12 has the frame member 21, the heat diffusion member 32 may be fixed to the cover members 20 and , 22or may be fixed to the frame member 21 and the substrate 25 together with the cover members 20 and 22.

The screws 46 are fastened into threaded holes of boss portions 46a provided on the mounting surface 25a of the substrate 25 or the surface of the heat diffusion member 32 on the Z2 side (see FIG. 5). Thus, the thermal module 24 (heat diffusion member 32) is detachably fixed to the frame member 21 directly or indirectly via the substrate 25.

Each fan 30 is fixed to the heat diffusion member 32 with screws (second screws) 47. The screws 47 are fastened, for example, from the Z1 side toward the Z2 side. For example, the two screws 47 which penetrate the fan chassis 38 and one screw 47 which penetrates a tongue-shaped plate piece protruding outside the fan chassis 38 may be used.

Each of the screws 47 is fastened into a threaded hole of a boss portion 47a provided on the surface 31d of the metal plate 31, for example. Thus, each fan 30 is detachably fixed to the metal plate 31. Note that the two boss portions 47a fixing the screws 47 which penetrate the fan chassis 38 may be inserted into holes 38c1 formed in the side wall material 38c (see FIGS. 4 and 5).

Next, the replacement operation of the fan 30 will be described.

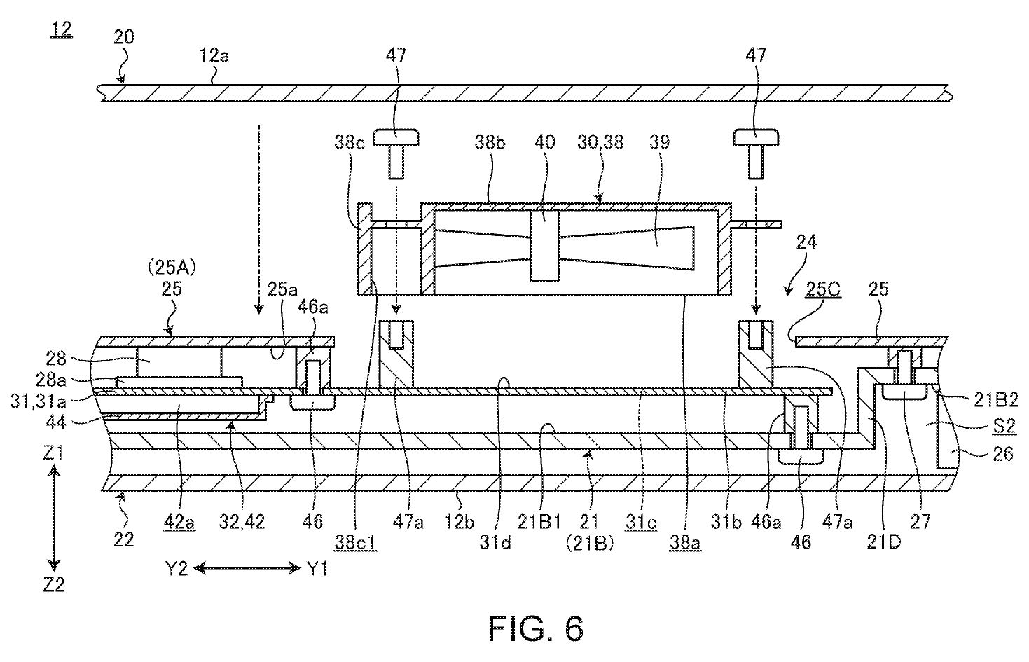

FIG. 6 is a cross-sectional side view illustrating the replacement operation of the fan 30 illustrated in FIG. 5. In the electronic apparatus 10, there is a possibility that the fan 30 may fail with the thermal module 24 mounted in the chassis 12 as illustrated in FIG. 5. In this case, the electronic apparatus 10 is capable of easily replacing the failed fan 30 independently.

As illustrated in FIG. 6, first, the screws, hook structures, and the like are removed to detach the first cover member 20 from the frame member 21. As a result, the fan 30 is exposed and the heads of the three screws 47 are also exposed. Thus, the screws 47 are removed to detach the fan 30 from the metal plate 31. This allows the failed fan 30 to be easily removed from the surface 31d of the metal plate 31.

Next, a new fan 30 is installed. As illustrated in FIG. 6, first, the replaced fan 30 is placed in the location where the failed fan 30 was provided. That is, the fan 30 is placed on the surface 31d of the metal plate 31 with the opening surface 38a facing downward. Next, the three screws 47 are fastened into the boss portions 47a. As a result, the fan 30 is fixed to the metal plate 31. Finally, the first cover member 20 is attached to the frame member 21 via the predetermined screws, hook structures, etc. Thus, the replacement operation of the fan 30 is completed.

As described above, the electronic apparatus 10 of the present embodiment includes the chassis 12, the substrate 25 on which the heating element is mounted and supported by the chassis 12, the heat diffusion member 32 having the metal plate 31 and capable of diffusing heat from the heating element, and the fans 30. The fan 30 has the fan chassis 38 having the opening surface 38a on one side thereof, and the fan blade 39 supported within the fan chassis 38. The heat diffusion member 32 is fixed to at least one of the cover members 20 and 22, the frame member 21, and the substrate 25 with the screws 46. That is, the heat diffusion member 32 may be fixed to the cover members 20 and 22 together with the frame member 21 or the substrate 25 with the screws 46, or may be fixed to the cover members 20 and 22 only with the screws 46. In other words, the heat diffusion member 32 may be fixed to the chassis 12 or a member fixed to the chassis 12. The fan chassis 38 is fixed to the metal plate 31 with the screws 47, and the opening surface 38a is closed by the metal plate 31.

Thus, in the electronic apparatus 10, the metal plate 31 constituting the heat diffusion member 32 also serves as a cover plate (fan cover) which closes the opening surface 38a of the fan chassis 38. Therefore, in the electronic apparatus 10, the metal plate 31 which diffuses heat from the heating element such as the CPU 28 can be directly cooled by cool air in the fan 30. For this reason, the electronic apparatus 10 can also obtain high cooling performance.

Further, in the case where the fan 30 in the electronic apparatus 10 fails, the chassis 12 is opened to expose the inside, and then the screws 47 are removed. This alone allows the fan 30 to be removed from the metal plate 31 and replaced. In this way, the electronic apparatus 10 allows the failed fan 30 to be easily replaced independently. Accordingly, the electronic apparatus 10 eliminates the need to replace the entire thermal module 24 including the heat diffusion member 32 when replacing the fan 30. Therefore, the electronic apparatus 10 can reduce the repair cost required for replacing the fan 30 and can also be compatible with ESG. Further, when replacing the fan 30, there is no need to replace the metal plate 31 which closes one surface of the fan chassis 38, thereby making it possible to further reduce the cost of parts required for replacement.

The heat diffusion member 32 may have the vapor chamber 42 which forms the sealed space 42a between the metal plate 31 and the plate 44. Here, it is preferable that the metal plate 31 has the extension plate part 31b extending from a portion thereof forming the sealed space 42a. The fan chassis 38 is preferably fixed to the extension plate part 31b with the screws 47. Thus, the vapor chamber 42 further improves the cooling performance of the heat diffusion member 32.

On the other hand, the opening surface 38a of the fan 30 is closed only by one thin extension plate part 31b. Consequently, it is possible to minimize the substantial height of the fan 30, specifically the height from the base plate part 31a to the metal plate 31. That is, the electronic apparatus 10 can suppress the substantial height of the fan 30 compared to the configuration in which the entire vapor chamber also serves as the fan cover, as in the configuration of Japanese Patent No. 7254891 described above. Incidentally, since the extension plate part 31b also functions as the portion to diffuse the heat from the CPU 28 or the like, the heat dissipation effect of the metal plate 31 by the fan 30 can be ensured. Incidentally, the extension plate part 31b does not have the sealed space 42a. Therefore, the fastening structure of the fan 30 to the extension plate part 31b by the screws 47 can be simplified.

Further, the vapor chamber 42 is formed integrally with the metal plate 31, thereby maintaining high cooling performance and no requiring removal when replacing the fan 30. Therefore, even though the electronic apparatus 10 has the configuration in which the heat diffusion member 32 has the vapor chamber 42, the fan 30 can be replaced independently. The same applies to the case where the heat pipe is joined to the metal plate 31 instead of the vapor chamber 42 as described above. That is, the heat pipe can be integrally jointed to the metal plate 31, and high cooling performance can be maintained. Note that in the configuration of Japanese Patent No. 7371170 described above, there is a need to fix the heat pipe and the fan separately in order to replace the fan alone, which may result in a deterioration in the cooling performance.

In the electronic apparatus 10, the substrate 25 and the fan 30 are arranged side by side on the same surface 31d side of the metal plate 31. This prevents the thick substrate 25 and the fan 30 from overlapping in the Z direction on the surface 31d side of the metal plate 31 and contributes to making the chassis 12 thinner.

In this case, the metal plate 31 may be fixed to the substrate 25 with the screws 46 so as to cover a part of the mounting surface 25a together with the CPU 28 and the like. The fan chassis 38 may be fixed with the screws 47 to the surface 31d of the metal plate 31 on the side opposite to the mounting surface 25a. Thus, the metal plate 31 can be securely thermally connected to the CPU 28 or the like being the heating element. Further, the fan 30 can also be smoothly fixed in the position where it does not overlap the substrate 25 vertically.

The chassis 12 may be configured to have the first cover member 20 which forms one side surface in the thickness direction, the second cover member 22 which forms the other side surface, and the frame member 21 to which the cover members 20 and 22 are each detachably connected. In this case, preferably, the metal plate 31 is arranged between the frame member 21 and the first cover member 20, and the portion 25A being part of the substrate 25 and the fan 30 are arranged between the metal plate 31 and the first cover member 20. This makes it possible to easily replace the fan 30 by simply removing the first cover member 20 which forms one surface of the chassis 12.

In this case, the screws 46 may be provided in the direction from the second cover member 22 side toward the first cover member 20 side, and the screws 47 may be provided in the direction from the first cover member 20 side toward the second cover member 22 side. Thus, since the screws 46 and 47 face opposite to each other, the height of the fan 30 can be utilized to install the substrate 25. Therefore, it is possible to suppress the height of the thermal module 24 and its peripheral components within the chassis 12, inclusive of the screws 46 and 47 and the boss portions 46a and 47a. Further, when the first cover member 20 is removed upon replacing the fan 30, the heads of the screws 46 which do not need to be removed are not exposed. Therefore, the screws 47 to be removed when replacing the fan 30 become clear, thereby improving workability.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### Description of Symbols

10 electronic apparatus

12 chassis

20 first cover member

21 frame member

22 second cover member

24 thermal module

25 substrate

27, 46, 47 screw

28 CPU

30 fan

31 metal plate

31b extension plate part

32 heat diffusion member

38 fan chassis

38a opening surface

39 fan blade

42 vapor chamber

44 plate

What is claimed is:

1. An electronic apparatus comprising:
a chassis;
a substrate mounted with a heating element and supported by the chassis;
a heat diffusion member having a metal plate and capable of diffusing heat of the heating element; and
a fan having a fan chassis including an opening surface on one side of the fan chassis, and a fan blade supported within the fan chassis,
wherein the heat diffusion member is fixed to at least one of the chassis and the substrate with a first screw, and
wherein the fan chassis is fixed to the metal plate with a second screw, and the opening surface is closed by the metal plate.

2. The electronic apparatus according to claim 1, wherein the heat diffusion member has a vapor chamber in which a sealed space is formed between two plates made of metal, one of which is formed of the metal plate,
wherein the metal plate has an extension plate part extending from a portion of the metal plate forming the sealed space, and
wherein the fan chassis is fixed to the extension plate part with the second screw.

3. The electronic apparatus according to claim 1, wherein the substrate and the fan are arranged on a same surface side of the metal plate.

4. The electronic apparatus according to claim 3, wherein the substrate has a mounting surface on which the heating element is mounted,
wherein the metal plate is fixed to the substrate with the first screw, and the metal plate covers a part of the mounting surface together with the heating element, and
wherein the fan chassis is fixed to a surface of the metal plate facing the mounting surface with the second screw.

5. The electronic apparatus according to claim 1, wherein the chassis includes:
a first cover member forming a surface on one side in a thickness direction;
a second cover member forming a surface on the other side; and
a frame member arranged between the first cover member and the second cover member and to which the first cover member and the second cover member are each detachably connected,
wherein the metal plate is arranged between the frame member and the first cover member,
wherein a part of the substrate is arranged between the metal plate and the first cover member, and
wherein the fan is arranged between the metal plate and the first cover member.

6. The electronic apparatus according to claim 5, wherein the first screw is provided in a direction from the second cover member side toward the first cover member side, and
wherein the second screw is provided in a direction from the first cover member side toward the second cover member side.
